(19) United States
(12) Patent Application Publication
(10) Pub. No.: US 2014/0033931 A1
(43) Pub. Date: Feb. 6, 2014

(54) FRYING AND ROASTING DEVICE WITH MINUTE-PRESSURE

(71) Applicant: Hui CHEN, Zhang Zhou (CN)

(72) Inventor: Hui CHEN, Zhang Zhou (CN)

(73) Assignee: TSANN KUEN (ZHANG ZHOU) ENTERPRISE CO., LTD., Zhangzhou (CN)

(21) Appl. No.: 13/565,176

(22) Filed: Aug. 2, 2012

(51) Int. Cl. A47J 37/06

(52) U.S. Cl. 99/351

(57) ABSTRACT

A grill with minute-pressure has an upper and lower comal group, and a minute-pressure mechanism. The minute-pressure mechanism comprises: a rotary carrying rod having two back carrying rods and a front carrying rod. The two back carrying rods are fixed to the upper comal group, the front carrying rod arms are rotatably connected to the two back carrying rods and rotate along the two sides of the upper comal group, two pressure springs and two pressing buckles that are arranged inside the front carrying rod ends and can drive the pressure springs in the front carrying rod arms, and two locating pins are arranged at the front carrying rod arms; two curved guide rails, arranged at the lower comal group sides and used for clamping the pressing buckles; and two groups of locating slots, are arranged at the lower comal group sides and used for fixing the locating pins.

### FIELD OF THE INVENTION

The present invention relates to a frying and roasting device, more particularly to a frying and roasting device with minute-pressure.

### BACKGROUND OF THE INVENTION

During the frying and roasting process of the frying and roasting device at the prior art, the weight of the upper comal group of the frying and roasting device is used for squeezing the food. The weight of the upper comal group has to fulfill certain demands to get good food squeezing effect, so that the frying and roasting device is ponderous; and when the thickness of the food is big, especially the food with much oil, such as pork burgers, the squeezing effect is not obvious by using the self-weight of the upper comal group to squeeze.

### SUMMARY OF THE INVENTION

The object of the present invention is to overcome the technical problem at the prior art, and offer a frying and roasting device with minute-pressure which is provided with compact structure and good squeezing effect.

The technical proposal in the present invention to solve the technical problems above is:

A frying and roasting device with minute-pressure comprises an upper comal group and a lower comal group, and it further comprises a minute-pressure mechanism, and the minute-pressure mechanism comprises:

A rotary carrying rod, which comprises two back carrying rods and a front carrying rod, the two back carrying rods are fixed to the upper comal group, the two arms of the front carrying rod are rotationally connected to the two back carrying rods and rotate along the two sides of the upper comal group, two pressure springs and two pressing buckle that are arranged in the inside of the two ends of the front carrying rod and can drive the pressure springs compact and loose are arranged in the two arms of the front carrying rod respectively, and two locating pins are arranged at the two arms of the front carrying rod respectively;

Two curved guide rails, which are arranged at the two sides of the lower comal group and used for clamping the pressing buckles;

Two group of locating slots, which are are arranged at the two sides of the lower comal group and used for fixing the locating pins.

In a preferred embodiment, the front carrying rod is U-shaped.

In a preferred embodiment, the minute-pressure mechanism further comprises a U-shaped drawing rod arranged in the inside cavity of the front carrying rod, two wedges are arranged at the two end of the drawing rod respectively, a drawing rod switch drawing the U-shaped drawing rod is arranged at the front carrying rod, two stucking holes coupling with the wedges are arranged at the ends of the two back carrying rods respectively.

In a preferred embodiment, two wedge springs are arranged at the two arms of the U-shaped drawing rod respectively, one end of the wedge spring contacts with the wedge, another end is fixed to the drawing rod.

In a preferred embodiment, two cavities are arranged in the two arms of the front carrying rod respectively, and two pinch plates are arranged under the two arms of the front carrying rod respectively, and the pinch plates are coupling with the cavities and fixed to the two arms of the front carrying rod, and the pinch plates are rotationally connected to the back carrying rods.

In a preferred embodiment, the minute-pressure mechanism further comprises a pair of locating rod and a pair of returning springs, a through hole is arranged at the pinch plate, the locating pin runs through the through hole, and the returning spring is clamped in the through hole and is compressed by the two arms of the front carrying rod, and one end of the locating rod is fixed to the drawing rod, and a bending boss driving the locating pin move sidelong is arranged at the other end of the locating rod.

In a preferred embodiment, two bumpings are arranged at the two sides of the lower comal group respectively, the curved guide rail is arranged at the bottom of the bumpings.

In a preferred embodiment, each group of the locating slots comprises at least one slot hole and is assigned in pairs at the bumping according to the rotation angle of the front carrying rod.

In a preferred embodiment, the pressing buckle is L-shaped with cavity for containing the pressure spring.

Compared with prior art, the benefits of the said technical proposal are:

1 During the rotating process of the rotary carrying rod, the buckle of the U-shaped front carrying rod is clamped to the curved guide rail to press the upper comal group and the lower comal group, so that the extruding force acted on the food between the upper comal group and the lower comal group is stronger, and it is good for squeezing the food.

2 During the rotating process of the rotary carrying rod, the locating pin is inserted in the locating slot, and the rotary carrying rod does not slip, so that the extruding force acted on the food between the upper comal group and the lower comal group is more stable and durable.

3 The pressure spring is arranged in the cavity of the L-shaped buckle, so that the structure of the front carrying rod is more compact.

### BRIEF DESCRIPTION OF THE DRAWINGS

FIG. 1 shows three-dimensional diagram of the frying and roasting device with minute-pressure in the present invention when it is in minute-pressure status;

FIG. 2 shows the abridged general view of the rotary carrying rod in the present invention;

FIG. 3 shows the partial amplifying abridged general view of the A part of the rotary carrying rod in FIG. 2.

FIG. 4 shows abridged general view of the frying and roasting device with minute-pressure in the present invention when it is at normal status.

### DESCRIPTION OF THE PREFERRED EMBODIMENTS

With the following description of the drawings and specific embodiments, the invention shall be further described in details.

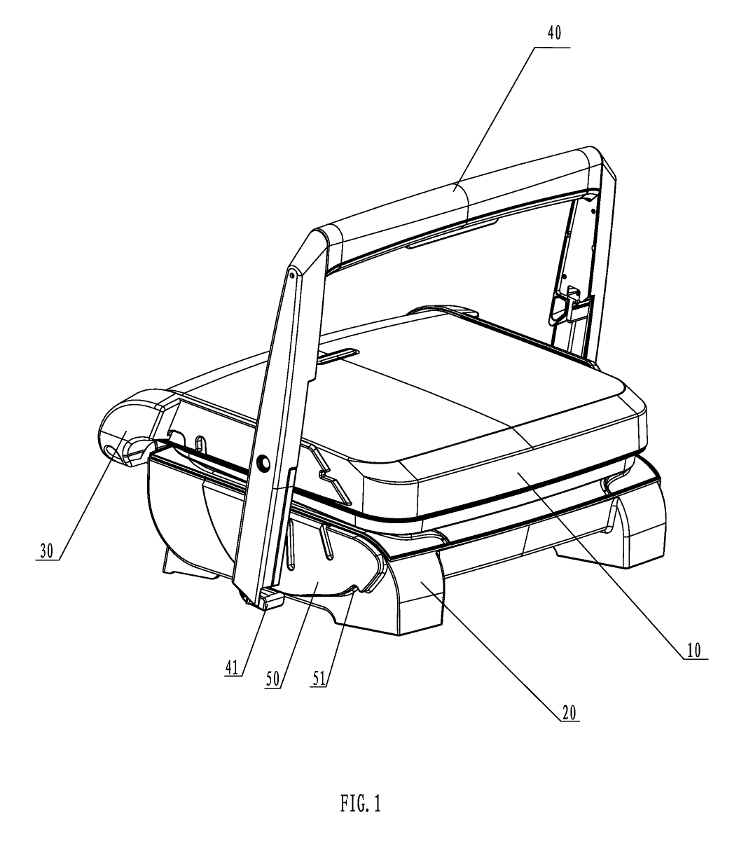

As shown in FIGS. 1, 2 and 3, the frying and roasting device with minute-pressure in the present invention comprises: a upper comal group 10, a lower comal group 20 and minute-pressure mechanism; the upper comal group 10 is rotationally or translationally connected to the lower comal group 20, but the way of the connection is not limited; the minute-pressure mechanism comprises a rotary carrying rod 40, two curved guide rails 51 and two groups of locating slots 52, the rotary carrying rod 40 comprises two back carrying rod 30 and 30′ and a front carrying rod 40, the front carrying rod 40 can be U shape, the two back carrying rod 30 and 30′ are fixed to the two sides of the upper comal group 10 respectively, the two arms 60 and 60′ of the front carrying rod 40 are rotationally connected to the two back carrying rod 30 and 30′ respectively, the front carrying rod 40 rotate along the two sides of the upper comal group 10, two pressure springs 62 and pressing buckles 41 are arranged in the two arms 60 and 60′ of the front carrying rod 40 respectively, the pressing buckles 41 are arranged in the inside of the two ends of the front carrying rod 40 and can drive the pressure springs 62 compact and loose, two locating pins 63 are arranged at the two arms 60 and 60′ of the front carrying rod 40 respectively; two bumpings 50 and 50′ are arranged at the two sides of the lower comal group 20 respectively, the curved guide rails 51 are arranged under the two bumpings 50 and 50′. The two groups of locating slots 52 are arranged at the two sides of the lower comal group and used for fixing the locating pins 63 when the front carrying rod 40 drives the locating pins 63 rotate.

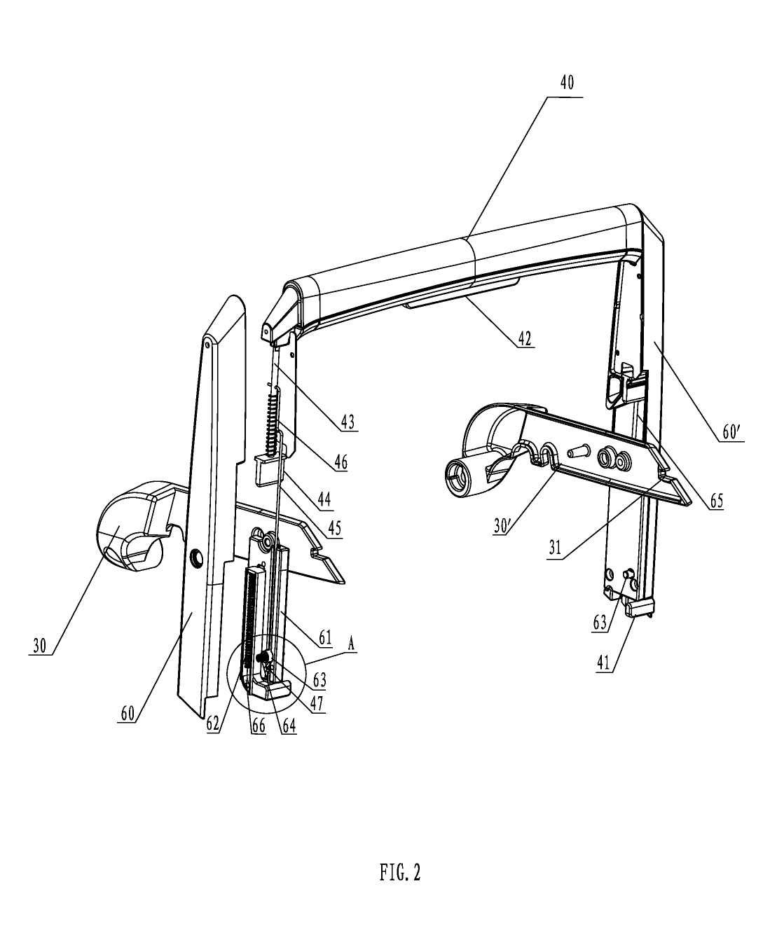

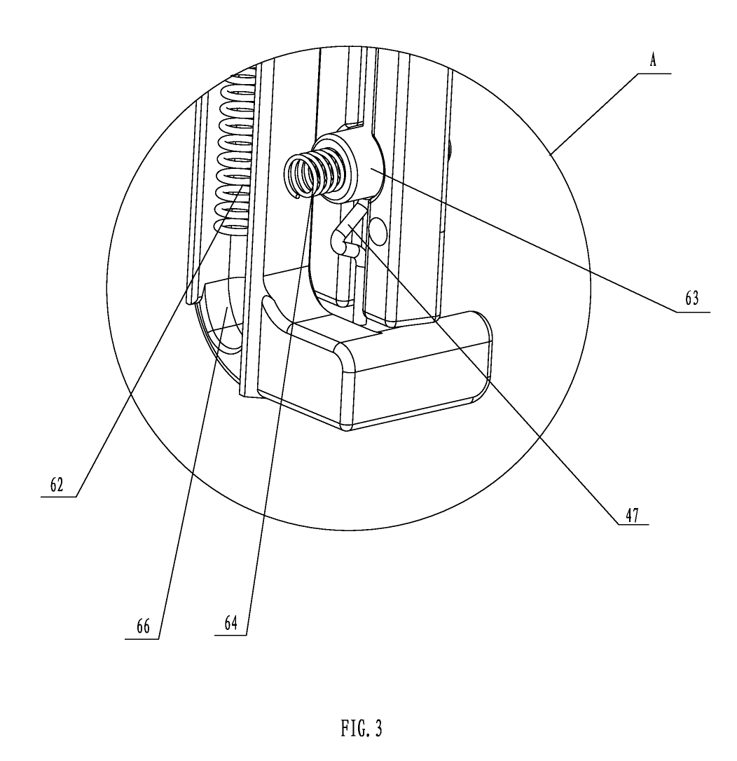

As shown in FIGS. 2 and 3, the minute-pressure mechanism further comprises a U-shaped drawing bar 43 which is arranged in the inside cavity of the front carrying rod 40, two wedges 44 are arranged at the two ends of the drawing rod 43 respectively, a drawing rod switch 42 for drawing the U-shaped drawing rod 43 is arranged on the front carrying rod 40. Two stucking holes 31 are arranged at the ends of the two back carrying rod 30 and 30, when the front carrying rod 40 is parallel to the two back carrying rod 30 and 30′, the stucking holes 31 are coupling with the wedges 44, and the wedges 44 are fixed in the stucking holes 31. Two wedge springs 46 are arranged at the two arms of the U-shaped carrying rod 43 respectively, one end of the wedge spring 46 contacts with the wedge 44, another end is fixed to the drawing rod 43. Two cavities 55 are arranged in the two arms 50 and 60′ of the front carrying rod 40 respectively, and two pinch plates 61 are arranged under the two arms 60 and 60′ of the front carrying rod 40 respectively, and the pinch plates 61 are coupling with the cavities 65 and are fixed to the two arms 60 and 60′ of the front carrying, rod 40, the pinch plates are rotationally connected to the back carrying rod 30 or 30′. The pressing buckle 41 is L-shaped with cavity 66 for containing the pressure spring 62.

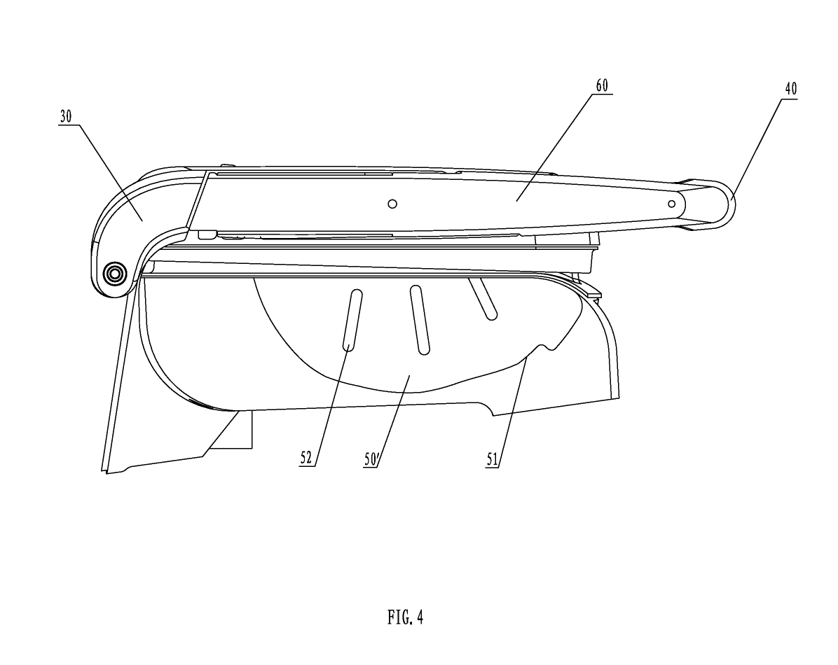

As shown in FIGS. 1, 2 and 4, the minute-pressure mechanism further comprises a pair of locating rods 45, a pair of returning spring 64, and a through hole is arranged on the pinch plate 61, and the locating pin 63 runs through the through hole, the returning spring 64 is clamped in the through hole and compressed by the two arms 60 or 60′ of the front carrying rod 40, one end of the locating rod 45 is fixed to the drawing rod 43, and a bending boss 47 driving the locating pin 63 move sidelong is arranged at the other end of the locating rod 45. Two bumpings 50 and 50′ are arranged at the two sides of the lower comal group 20 respectively, the curved guide rail 51 is arranged at the bottom of the bumping 50 or 50′. Each group of the locating slots 52 comprises at least one slot hole and is assigned in pairs at the bumping 50 or 50′ according to the rotation angle of the front carrying rod 40.

As shown in FIGS. 1, 2 and 4, the drawing rod switch 42 is turned on, and then the U-shaped drawing rod is pulled up, and then the wedges 44 at the two ends of the U-shaped drawing rod are pull out from the back carrying rod 30 and 30′, the front carrying rod 40 gets loose from the back carrying rod 30 and 30′, and then the pressing buckles 41 enter the curved guide rails 51 under the bumpings 50 and 50′ and rotate along the curved guide rails 51, and the wedge springs 46 are compressed, the U-shaped drawing rod 43 links the locating rod 45 simultaneously, and the bending boss 47 of the locating rod 45 drives the locating pins 63 move outward, and the returning spring 64 is compressed, and the front carrying rod 40 rotate upward. When the locating pin 63 is corresponding to one of the locating slots 52 of the bumping 50, the drawing rod switch 42 is loosen, and then the locating pin 63 rebounds inwards caused by the returning spring 63, and then the locating pin 63 enters the locating slot 52 just in time to fix the front carrying rod 40 for the locating and pressing effect. If it is needed to rotate the front carrying rod 40 again, the drawing rod switch 42 is turned on again, and the locating pin 63 is located in another locating slot 52 to achieve the aim.

The invention has been described with reference to the preferred embodiments mentioned above; therefore it cannot limit the reference implementation of the invention. It is obvious to a person skilled in the art that structural modification and changes can be carried out without leaving the scope of the claims hereinafter and the description above.

What is claimed is:

1. A frying and roasting device with minute-pressure comprises an upper comal group and a lower comal group, wherein, it further comprises a minute-pressure mechanism, and the minute-pressure mechanism comprises:
A rotary carrying rod, which comprises two back carrying rods and a front carrying rod, the two back carrying rods are fixed to the upper comal group, the two arms of the front carrying rod are rotationally connected to the two back carrying rods and rotate along the two sides of the upper comal group, two pressure springs and two pressing buckle that are arranged in the inside of the two ends of the front carrying rod and can drive the pressure springs compact and loose are arranged in the two arms of the front carrying rod respectively, and two locating pins are arranged at the two arms of the front carrying rod respectively;
Two curved guide rails, which are arranged at the two sides of the lower comal group and used for clamping the pressing buckles;
Two group of locating slots, which are are arranged at the two sides of the lower comal group and used for fixing the locating pins.

2. A frying and roasting device with minute-pressure according to claim 1, wherein, the front carrying rod is U-shaped.

3. A frying and roasting device with minute-pressure according to claim 2, wherein, the minute-pressure mechanism further comprises a U-shaped drawing rod arranged in the inside cavity of the front carrying rod, two wedges are arranged at the two end of the drawing rod respectively, a drawing rod switch drawing the U-shaped drawing rod is arranged at the front carrying rod, two stucking holes coupling with the wedges are arranged at the ends of the two back carrying rods respectively.

4. A frying and roasting device with minute-pressure according to claim 3, wherein, two wedge springs are arranged at the two arms of the U-shaped drawing rod respectively, one end of the wedge spring contacts with the wedge, another end is fixed to the drawing rod.

5. A frying and roasting device with minute-pressure according to claim 2, wherein, two cavities are arranged in the two arms of the front carrying rod respectively, and two pinch plates are arranged under the two arms of the front carrying rod respectively, and the pinch plates are coupling with the cavities and fixed to the two arms of the front carrying rod, and the pinch plates are rotationally connected to the back carrying rods.

6. A frying and roasting device with minute-pressure according to claim 5, wherein, the minute-pressure mechanism further comprises a pair of locating rod and a pair of returning springs, a through hole is arranged at the pinch plate, the locating pin runs through the through hole, and the returning spring is clamped in the through hole and is compressed by the two arms of the front carrying rod, and one end of the locating rod is fixed to the drawing rod, and a bending boss driving the locating pin move sidelong is arranged at the other end of the locating rod.

7. A frying and roasting device with minute-pressure according to claim 1, wherein, two bumpings are arranged at the two sides of the lower comal group respectively, the curved guide rail is arranged at the bottom of the bumpings.

8. A frying and roasting device with minute-pressure according to claim 7, wherein, each group of the locating slots comprises at least one slot hole and is assigned in pairs at the bumping according to the rotation angle of the front carrying rod.

9. A frying and roasting device with minute-pressure according to claim 1, wherein, the pressing buckle is L-shaped with cavity for containing the pressure spring.
